(19) United States
(12) Patent Application Publication
(10) Pub. No.: US 2020/0412547 A1
(43) Pub. Date: Dec. 31, 2020

(54) METHOD AND APPARATUS FOR AUTHENTICATION OF RECORDED SOUND AND VIDEO

(71) Applicant: Sony Corporation, Tokyo (JP)

(72) Inventor: Fredrik RUSEK, Lund (SE)

(21) Appl. No.: 16/962,546

(22) PCT Filed: Jun. 21, 2018
(86) PCT No.: PCT/US2018/038670

§ 371 Date: Jul. 16, 2020

(51) Int. Cl. H04L 9/32; H04L 9/08; H04N 19/124

(52) U.S. Cl. CPC H04L 9/3247; H04L 2209/60; H04N 19/124; H04L 9/0825

(57) ABSTRACT

A device includes a sensor configured to detect authentic audio and/or visual content. The device also includes a processor including an asymmetric cryptographic function using a mathematically paired private key and public key. The processor is configured to extract using a predetermined algorithm at least one predetermined parameter from the detected authentic audio and/or visual content, quantize the at least one extracted predetermined parameter into at least one first data sequence associated with the authentic audio and/or visual content, and encrypt using the asymmetric cryptographic function and the private key the at least one first data sequence to generate at least one signal. The device also includes a transmitter configured to transmit the at least one signal. The signal is embeddable as a digital signature in a recording of the authentic audio and/or visual content and is generated based on the authentic audio and/or visual content.

### TECHNICAL FIELD OF THE INVENTION

The technology of the present disclosure relates generally to authenticating audio and/or visual content, and more particularly to methods and devices for authenticating a recording of audio and/or visual content having a digital signature.

### DESCRIPTION OF THE RELATED ART

Due to advancements in the field, creating and altering recorded audiovisual content can now be done with ease. Words and facial movements of an individual giving a speech or making an oral agreement, for example, may be changed so that it appears that the individual said something that they never actually said. Though there may be witnesses to corroborate what the speaker actually said, this ability to alter recordings may nonetheless be damaging. For example, if a video of a high-profile individual making a statement is altered with damning content and uploaded to an online public platform, the individual may have a hard time proving to the public that the video is fake. Given the advancements in altering audio and/or visual recordings, it may soon be the case that no man-made computer will have the ability to verify whether a recording is of an actual event or merely synthetically produced or altered. Accordingly, video and sound recordings may soon no longer be a reliable source of proof of what an individual said or did.

### SUMMARY

Verification of the authenticity of recordings, therefore, is of critical importance. According to aspects of the present invention, an individual may generate a digital signature that is embeddable in any recording of their authentic audio and/or visual content. The digital signature, therefore, will be uniquely generated based on the authentic audio and/or visual content, and may provide a way to defend against any altered or fake recording of the content embedded with that digital signature. The digital signature may be based on the individual's audio and/or visual content as it is being authentically expressed and recorded by encrypting the authentic content using asymmetric cryptography and a private key, held only by the individual conveying the authentic content. If the content is recorded and later altered, it will not be possible for any other individual to appropriately alter the digital signature embedded in the recording and associated with the authentic content to instead be associated with the allegedly authentic content. Accordingly, a recording of allegedly authentic audio and/or visual content embedded with the digital signature may later be verified and authenticated by use of the asymmetric cryptographic function and a mathematically paired public key.

Accordingly, in one aspect of the invention, a first device comprises a sensor configured to detect authentic audio and/or visual content. The first device also comprises a processor including an asymmetric cryptographic function using a mathematically paired private key and public key. The processor is configured to extract using a predetermined algorithm at least one predetermined parameter from the detected authentic audio and/or visual content, quantize the at least one extracted predetermined parameter into at least one first data sequence associated with the authentic audio and/or visual content, and encrypt using the asymmetric cryptographic function and the private key the at least one first data sequence to generate at least one signal. The first device also comprises a transmitter configured to transmit the at least one signal such that the signal is recordable and embeddable as a digital signature in a recording of the authentic audio and/or visual content, the digital signature being generated based on the authentic audio and/or visual content in the recording of the authentic audio and/or visual content.

In an embodiment, the at least one data sequence represents fundamental components of the at least one extracted predetermined parameter.

In another embodiment, the at least one predetermined parameter includes at least one of eye movement, lip movement, and sound characteristics.

In yet another embodiment, the at least one signal is detectable by a recording device.

In another embodiment, the at least one signal includes at least one of a sound signal and an electromagnetic signal.

In another embodiment, the processor is further configured to extract using the predetermined algorithm the at least one predetermined parameter from a recording of allegedly authentic audio and/or visual content embedded with the digital signature generated based on the authentic audio and/or visual content. The processor is also further configured to quantize the at least one extracted predetermined parameter into at least one second data sequence associated with the allegedly authentic audio and/or visual content, and verify using the asymmetric cryptographic function and the public key whether the at least one second data sequence could generate the digital signature embedded in the recording of allegedly authentic audio and/or visual content.

In another embodiment, the processor is further configured such that when the processor verifies that the at least one second data sequence could generate the digital signature embedded in the recording of allegedly authentic audio and/or visual content, the digital signature being generated based on the authentic audio and/or visual content, the processor determines that the recording of allegedly authentic audio and/or visual content is of the authentic audio and/or visual content. When the processor verifies that the at least one second data sequence could not generate the digital signature embedded in the recording of the allegedly authentic audio and/or visual content, the digital signature being generated based on the authentic audio and/or visual content, the processor determines that the recording of allegedly authentic audio and/or visual content is not of the authentic audio and/or visual content.

In another aspect of the invention, a second device comprises a processor including an asymmetric cryptographic function. The processor is configured to extract using a predetermined algorithm at least one predetermined parameter from a recording of allegedly authentic audio and/or visual content embedded with a digital signature generated based on authentic audio and/or visual content, quantize the at least one extracted predetermined parameter into at least one second data sequence associated with the allegedly authentic audio and/or visual content, and verify using the asymmetric cryptographic function and a public key whether the at least one second data sequence could generate the digital signature embedded in the recording of allegedly authentic audio and/or visual content.

In an embodiment, the processor is further configured such that when the processor verifies that the at least one second data sequence could generate the digital signature embedded in the recording of allegedly authentic audio and/or visual content, the digital signature being generated based on the authentic audio and/or visual content, the processor determines that the recording of allegedly authentic audio and/or visual content is of the authentic audio and/or visual content. When the processor verifies that they at least one second data sequence could not generate the digital signature embedded in the recording of the allegedly authentic audio and/or visual content, the digital signature being generated based on the authentic audio and/or visual content, the processor determines that the recording of allegedly authentic audio and/or visual content is not of the authentic audio and/or visual content.

In another aspect of the invention, a method comprises detecting authentic audio and/or visual content, extracting using a predetermined algorithm at least one predetermined parameter from the detected authentic audio and/or visual content, quantizing the at least one extracted predetermined parameter into at least one first data sequence associated with the authentic audio and/or visual content, encrypting using an asymmetric cryptographic function and a private key the at least one first data sequence to generate at least one signal, and transmitting the at least one signal such that the signal is recordable and embeddable as a digital signature in a recording of the authentic audio and/or visual content, the digital signature being generated based on the authentic audio and/or visual content in the recording of authentic audio and/or visual content.

In an embodiment, the at least one data sequence represents fundamental components of the at least one extracted predetermined parameter.

In another embodiment, the at least one predetermined parameter includes at least one of eye movement, lip movement, and sound characteristics.

In yet another embodiment, the at least one signal is detectable by a recording device.

In another embodiment, the at least one signal includes at least one of a sound signal and an electromagnetic signal.

In another embodiment, method further comprising extracting using the predetermined algorithm the at least one predetermined parameter from a recording of allegedly authentic audio and/or visual content embedded with the digital signature generated based on the authentic audio and/or visual content, quantizing the at least one extracted predetermined parameter into at least one second data sequence associated with the allegedly authentic audio and/or visual content, and verifying using the asymmetric cryptographic function and a public key whether the at least one second data sequence could generate the digital signature embedded in the recording of allegedly authentic audio and/or visual content.

In another embodiment, the method further comprises, when the at least one second data sequence could generate the digital signature embedded in the recording of allegedly authentic audio and/or visual content, the digital signature being generated based on the authentic audio and/or visual content, determining that the recording of allegedly authentic audio and/or visual content is of the authentic audio and/or visual content. The method also further comprises, when the at least one second data sequence could not generate the digital signature embedded in the recording of the allegedly authentic audio and/or visual content, the digital signature being generated based on the authentic audio and/or visual content, determining that the recording of allegedly authentic audio and/or visual content is not of the authentic audio and/or visual content.

In another aspect of the invention, a method comprises extracting using a predetermined algorithm at least one predetermined parameter from a recording of allegedly authentic audio and/or visual content embedded with a digital signature generated based on authentic audio and/or visual content, quantizing the at least one extracted predetermined parameter into at least one second data sequence associated with the allegedly authentic audio and/or visual content, and verifying using the asymmetric cryptographic function and a public key whether the at least one second data sequence could generate the digital signature embedded in the recording of allegedly authentic audio and/or visual content.

In an embodiment, the method further comprises, when the at least one second data sequence could generate the digital signature embedded in the recording of allegedly authentic audio and/or visual content, the digital signature being generated based on the authentic audio and/or visual content, determining that the recording of allegedly authentic audio and/or visual content is of the authentic audio and/or visual content. The method also further comprises, when the at least one second data sequence could generate the digital signature embedded in the recording of the allegedly authentic audio and/or visual content, the digital signature being generated based on the authentic audio and/or visual content, determining that the recording of allegedly authentic audio and/or visual content is not of the authentic audio and/or visual content.

In another embodiment, a non-transitory computer-readable medium storing program code which when executed performs the methods of the invention.

These and further features will be apparent with reference to the following description and attached drawings. In the description and drawings, particular embodiments have been disclosed in detail as being indicative of some of the ways in which principles of the invention may be employed, but it is understood that the invention is not limited correspondingly in scope. Rather, the invention includes all changes, modifications and equivalents coming within the spirit and terms of the claims appended hereto.

Features that are described and/or illustrated with respect to one embodiment may be used in the same way or in a similar way in one or more other embodiments and/or in combination with or instead of the features of the other embodiments.

The terms “comprises” and “comprising,” when used in this specification, are taken to specify the presence of stated features, integers, steps or components but do not preclude the presence or addition of one or more other features, integers, steps, components or groups thereof.

### BRIEF DESCRIPTION OF THE DRAWINGS

FIG. 1A is a schematic diagram of an exemplary device according to an aspect of the invention.

FIG. 1B is a schematic flow diagram of the exemplary device of FIG. 1A as operated according to an embodiment.

FIG. 1C is a schematic flow diagram of the exemplary device of FIG. 1A as operated according to another embodiment.

FIG. 2A is a schematic diagram of an exemplary device according to another aspect of the invention.

FIG. 2B is a schematic flow diagram of the exemplary device of FIG. 2A as operated according to an embodiment.

FIG. 3A is a flow diagram of an exemplary method according to an aspect of the invention.

FIG. 3B is a flow diagram of an embodiment of the exemplary method of FIG. 3A.

FIG. 4 is a flow diagram of an exemplary method according to another aspect of the invention.

FIG. 5 is a schematic diagram of an exemplary device according to an aspect of the invention.

### DETAILED DESCRIPTION OF EMBODIMENTS

Embodiments of the present invention will now be described with reference to the drawings, wherein like reference numerals are used to refer to like elements throughout. It will be understood that the figures are not necessarily to scale.

In any situation where authentic audio and/or visual content may be recorded and thereafter altered in the recording, an individual providing the authentic audio and/or visual content in real-time may use aspects of the present invention to ensure that a digital signature, uniquely generated based on the authentic audio and/or visual content, is embedded in all recordings of the authentic content. In this way, any recording embedded with the digital signature and having allegedly authentic audio and/or visual content may be verified and authenticated by checking to see if the allegedly authentic audio and/or visual content in the recording could generate the embedded digital signature in the same way that the digital signature is generated based on the authentic audio and/or visual content. The present invention makes use of asymmetric cryptography using a mathematically paired private key and public key. The private key is used to encrypt data representative of the authentic audio and/or visual content into signals that are embedded as a digital signature in any recording of the authentic content, while the public key may be used to verify whether the allegedly authentic content could similarly generate the embedded digital signature.

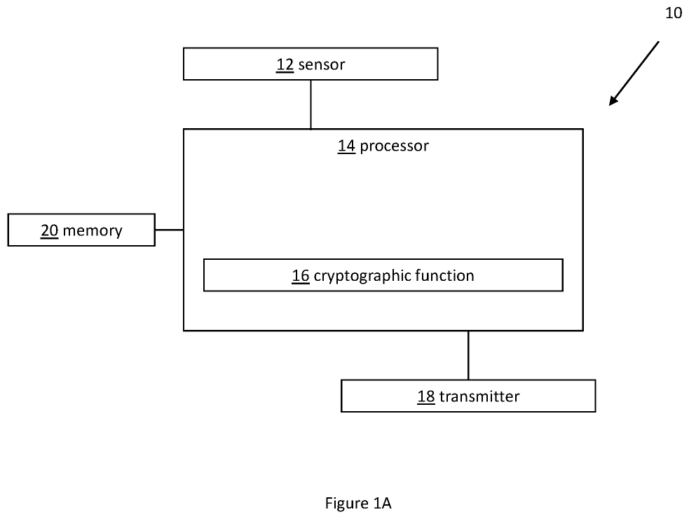

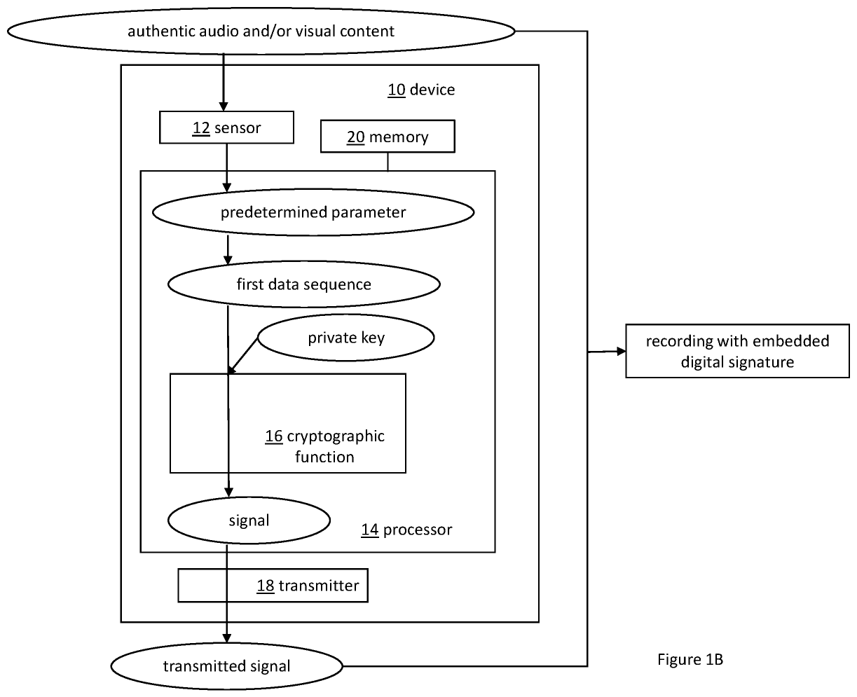

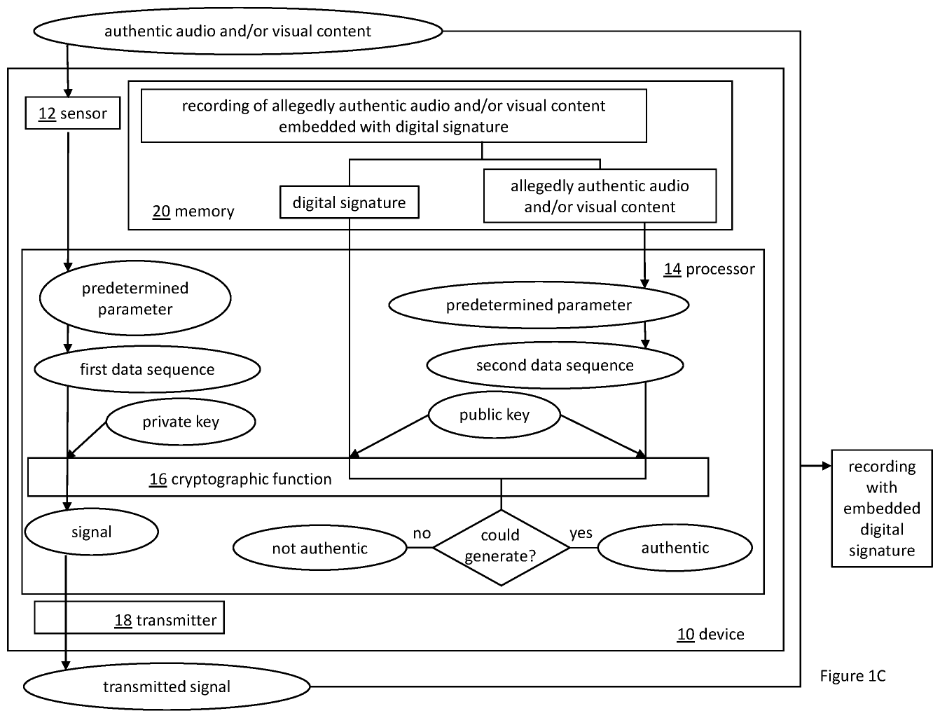

With reference to FIGS. 1A and 1B, a first device 10 configured to generate at least one signal to be recorded and embedded as a digital signature in a recording of authentic audio and/or visual content, and its use in accordance with the present invention, is depicted. The first device 10 may be, for examples used herein, a first portable electronic device. The first portable electronic device 10 comprises a sensor 12 configured to detect authentic audio and/or visual content, for example, in real-time. The authentic audio and/or visual content may be of, for example, a speaker giving a speech, or an individual in a meeting making an oral agreement. The sensor 12 may be for example, a camera, an audio receiver, or any other suitable sensor capable of detecting audio and/or visual content. An individual seeking to have the authentic audio and/or visual content protected from any subsequent alterations in a recording may place the first portable electronic device 10 nearby such that the sensor 12 detects the authentic audio and/or visual content, for example, in real-time as it is conveyed.

The first portable electronic device 10 also comprises a processor 14 configured to perform a number of functions as will be described in greater detail below. The processor 14 ultimately generates at least one signal to be transmitted such that the signal may be recorded by a recording device along with the authentic audio and/or visual content and embedded as a digital signature in any resulting recording of the authentic audio and/or visual content. The embedded digital signature, therefore, may be generated based on the authentic audio and/or visual content.

The processor 14 is configured to extract using a predetermined algorithm at least one predetermined parameter from the authentic audio and/or visual content detected by the sensor 12. The predetermined parameter may be, for example, various sound characteristics, such as a person's voice, volume or pitch in the audio content and/or specific facial features, such as eye or lip movement in the visual content. Lip movements that can be extracted and analyzed may be, for example, lip spacing or lip shape. The predetermined algorithm that is used is specific to the predetermined parameter that is meant to be extracted and may be chosen according to standards known in the art.

The processor 14 is configured to quantize the extracted parameters into at least one data sequence (also referred to herein as “at least one first data sequence”) representative of the extracted parameters for further processing into at least one signal. The processor 14 may be configured to quantize the extracted parameters such that the resulting data sequence represents fundamental components of the extracted parameters and does not represent background data or insignificant data variation. For example, in an embodiment where various sound characteristics are extracted as the predetermined parameters in the audio content, the processor 14 may quantize the sound characteristics such that the fundamental components of the extracted sound characteristics are components of the sound that are representative of only the speaker. The processor 14 may quantize the extracted sound characteristics via, for example, wavelet based compression, short-time Fourier transforms, or any other multiresolution analysis method. In another embodiment where specific facial features are extracted as the predetermined parameter in the visual content, the processor 14 may quantize the features such that the fundamental components of the extracted facial features are only significant movements and/or spacing of the speaker's facial features. The processor 14 may quantize the extracted facial features via, for example, wavelet based compression, short-time Fourier transforms, or any other multiresolution analysis method. In this way, any variation of detection angle or insubstantial movement variation will not be considered or will otherwise be given less consideration. Again, in this way, any background data, or “noise,” is not represented in the at least one first data sequence associated with the authentic audio and/or visual content. The processor may quantize the extracted parameters via 2D versions of the aforementioned methods, as will be appreciated.

The processor 14 includes an asymmetric cryptographic function 16 that uses a mathematically paired private key and public key for encryption of the data sequences into signals. The first portable electronic device 10 may be equipped with the private key, while the mathematically paired public key may be openly published. Accordingly, the data sequences, generally representative of the detected authentic audio and/or visual content and more specifically associated with the extracted parameters, may be input together with the private key into the asymmetric cryptographic function 16 of the processor 14 to be encrypted into at least one signal representative of that data. As the asymmetric cryptographic function 16 is configured to encrypt the data sequences to generate at least one signal representative of the data, the generated signals, which can be recorded and embedded as a digital signature, will be uniquely generated based on the authentic audio and/or visual content and may be used when verifying and authenticating allegedly authentic audio and/or visual content, as will be described in detail below. The encryption may only be done with the private key. In this way, only the holder of the private key, here the individual with the first portable electronic device 10 practicing this aspect of the invention, may generate the signals to be embedded as the digital signature, the signals being uniquely generated based on the authentic audio and/or visual content.

The first portable electronic device 10 also comprises a transmitter 18 configured to transmit the at least one signal so that it may be recorded and embedded as the digital signature in a recording. In an example, where both audio and visual parameters are extracted and encrypted, two signals may be generated, one for the encrypted audio content and one for the encrypted visual content. The first device 10 may transmit the signals for the encrypted visual content as light, or any other electromagnetic signal, also referred to herein as light signals. The first device 10 may transmit the signals for the encrypted audio content as sound, also referred to herein as sound signals. The sound signals may be, for example, one or more of ultrasound or infrasound. The light signals may be, for example, one or more of ultraviolet light or infrared light. The aforementioned signals may also be in the form of radio signals. Therefore, the light and/or sound signals may be undetectable by the human eye or ear. In an embodiment, however, the light and/or sound signals are at least detectable by a recording device, such that they may be embedded in a resulting recording. The signals may be transmitted so that they may be recorded together with the authentic audio and/or visual content by a recording device. For example, the signals may be transmitted as sound, flashing light, light projected onto the speaker's face or body, an image that is displayed to the audience (for example, by the display of a speaker's smartphone), such as a machine readable code or a QR code, or any combination thereof. The signals may be transmitted at a predetermined time-delay after encryption by the asymmetric cryptographic function 16. The signals may be transmitted from the first device 10 itself, or from some other apparatus in wireless or electronic communication with the first device 10, such as for example a flashing light clipped on the collar of the speaker or the podium at which the speaker stands. The signals may therefore be recorded and embedded as a digital signature in the recording of the authentic audio and/or visual content, the digital signature being uniquely generated based on the authentic audio and/or visual content. In an embodiment, the processor 14 may be configured to add a time-stamp to the signals as they are transmitted so that the embedded digital signature reflects the exact time of transmission of the signals. In this way, the time that the authentic audio and/or visual content was expressed will be reflected in the digital signature.

FIG. 1C depicts how the first portable electronic device 10, in an embodiment, may also be configured to verify whether a recording of allegedly authentic audio and/or visual content embedded with the digital signature generated based on the authentic audio and/or visual content is actually of the authentic audio and/or visual content or not. For example, when an individual uses the first device 10 while expressing authentic audio and/or visual content to generate at least one signal to be recorded and embedded as a digital signature as discussed above, and someone else records and thereafter alters the content in the recording, the individual may use the first device 10 according to this embodiment, to authenticate the recording. In one form, for example, the individual may use the first device 10 to download the recording of allegedly authentic audio and/or visual content from an online public forum to which it was published.

Accordingly, again with reference to FIGS. 1A and 1B, in this embodiment, the first device 10 may comprise a memory 20 configured to store the downloaded, or otherwise obtained, recording of allegedly authentic audio and/or visual content, the recording being embedded with the digital signature generated based on the authentic audio and/or visual content. The processor 14 is configured to extract from the allegedly authentic content the at least one predetermined parameter that was also extracted from the authentic content to generate the signals embedded as the digital signature. This may be done using the same predetermined algorithm specific to the predetermined parameter, as described earlier. The processor 14 is configured to quantize the at least one extracted predetermined parameter into at least one second data sequence, just as was done to obtain the at least one first data sequence. In a situation where the authentic audio and/or visual content has been altered in the recording, the at least one second data sequence obtained from the extracted parameters of the allegedly authentic audio and/or visual content will be different than the at least one first data sequence derived from the digital signature and representative of the extracted parameters of the authentic audio and/or visual content.

To authenticate the recording of allegedly authentic content, the processor 14 is configured to verify using the asymmetric cryptographic function 16 and the public key whether the at least one second data sequence could generate the same digital signature embedded in the recording of allegedly authentic audio and/or visual content. For example, because the digital signature is generated based on the authentic content, when the at least one second data sequence could generate the digital signature embedded in the recording, the processor 14 may determine that the recording of allegedly authentic audio and/or visual content is of the authentic audio and/or visual content. When, however, the at least one second data sequence could not generate the digital signature embedded in the recording, the processor 14 may determine that the recording of allegedly authentic audio and/or visual content is not of the authentic audio and/or visual content.

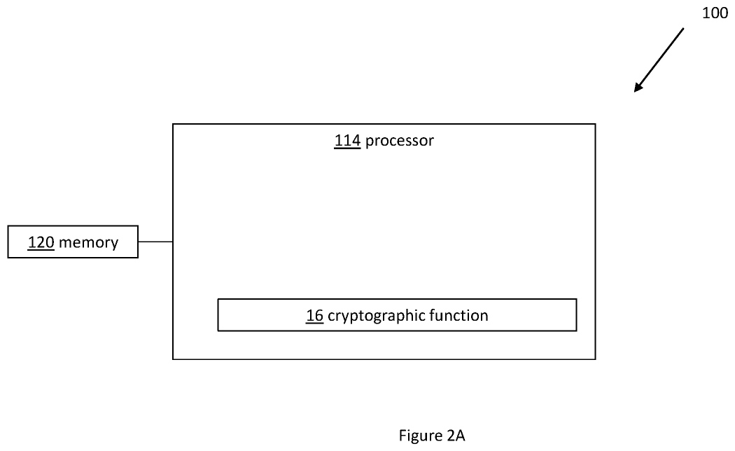

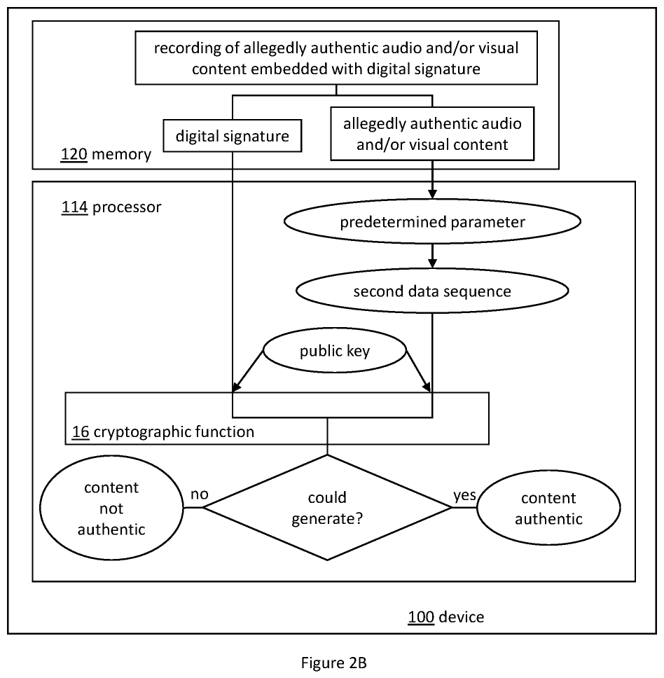

FIGS. 2A and 2B depict another embodiment of a second device 100 according to the invention. The second device 100 may also be, for examples used herein, a second portable electronic device. The second portable electronic device 100 is configured to verify whether a recording of allegedly authentic audio and/or visual content embedded with a digital signature generated based on authentic audio and/or visual content is actually of the authentic audio and/or visual content or not. The second portable electronic device 100 may only be equipped with the public key of the asymmetric cryptographic function 16, and an individual may therefore use the second portable electronic device 100 to authenticate a recording, however the second portable electronic device 100 may not be configured to encrypt new content using the asymmetric cryptographic function and the private key as the first portable electronic device 10 may be. In this way, though only an individual who has a device such as the first portable electronic device 10 having the private key may generate the signals to be embedded as the digital signature in a recording of the content of their speech, anyone having the public key may use the second portable electronic device 100 to authenticate the recording.

Accordingly, where there is a recording of allegedly authentic audio and/or visual content embedded with a digital signature generated based on authentic audio and/or visual content, the second portable electronic device 100 may authenticate the recording. In one embodiment, the second device 100 may comprise a memory 120 configured to store the recording of allegedly authentic audio and/or visual content and a processor 114 including an asymmetric cryptographic function 16. The processor 114 may be configured in the same manner as described in earlier embodiments, or in a different manner. Thus, the processor 114 may be configured to extract using a predetermined algorithm at least one predetermined parameter from the allegedly authentic audio and/or visual content. The predetermined parameter and the predetermined algorithm may be the same that were used to encrypt the authentic audio and/or visual content when generating the signals of the digital signature. The processor 114 may be configured to quantize the at least one extracted predetermined parameter into at least one second data sequence. The processor 114 may be configured to verify using the asymmetric cryptographic function 16 and the public key whether the at least one second data sequence could generate the digital signature embedded in the recording of allegedly authentic audio and/or visual content. Because the digital signature is generated based on the authentic audio and/or visual content, when the at least one second data sequence could generate the digital signature embedded in the recording, the processor 114 may determine that the recording of allegedly authentic audio and/or visual content is of the authentic audio and/or visual content. When, however, the at least one second data sequence could not generate with the digital signature embedded in the recording, the processor 114 may determine that the recording of allegedly authentic audio and/or visual content is not of the authentic audio and/or visual content.

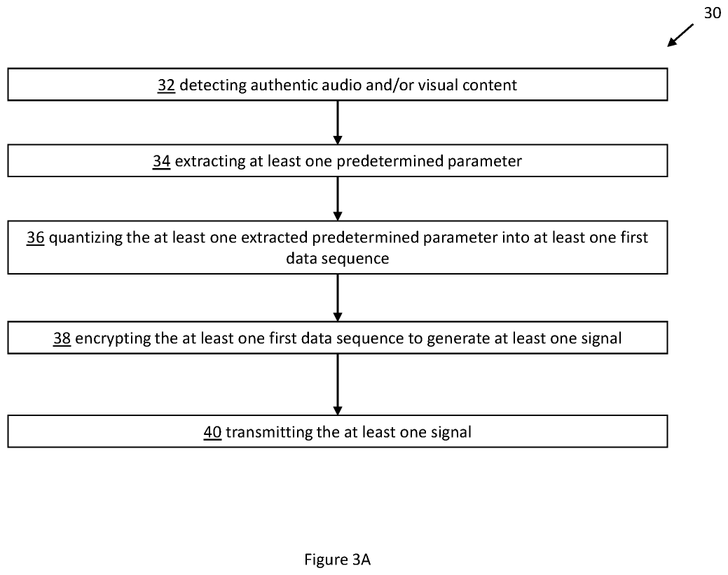

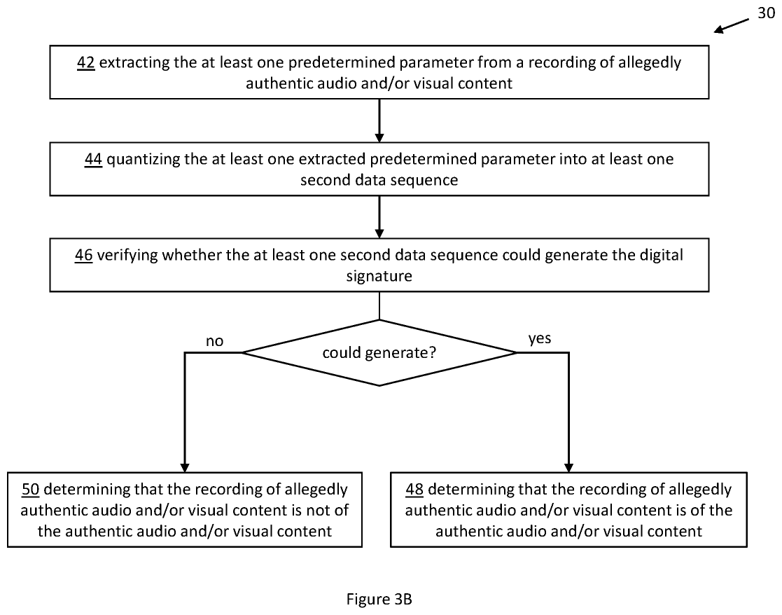

With reference to FIG. 3A, a method 30 of generating at least one signal to be recorded and embedded as a digital signature in a recording of authentic audio and/or visual content is depicted. The method 30 comprises detecting at 32 the authentic audio and/or visual content and extracting at 34 using a predetermined algorithm at least one predetermined parameter from the detected authentic audio and/or visual content. The predetermined parameter may be, for example, various sound characteristics, such as a person's voice, volume or pitch in the audio content and/or specific facial features, such as eye or lip movement in the visual content. The lip movement may be, for example, lip spacing. The predetermined algorithm that is used is specific to the predetermined parameter that is meant to be extracted and may be chosen according to standards known in the art.

The method 30 comprises quantizing at 36 the at least one extracted predetermined parameter into at least one first data sequence, representative of the extracted parameters, for further processing into at least one signal. The processor may be configured to quantize the extracted parameters such that the resulting data sequence represents fundamental components of the extracted parameters and does not represent background data or insignificant data variation. For example, in an embodiment, where various sound characteristics are extracted as the predetermined parameters in the audio content, the processor may quantize the sound characteristics such that the fundamental components of the extracted sound characteristics are components of the sound that are representative of only the speaker. The processor may quantize the extracted sound characteristics via, for example, wavelet based compression, short-time Fourier transforms, or any other multiresolution analysis method. In another embodiment, where specific facial features are extracted as the predetermined parameter in the visual content, the processor may quantize the features such that the fundamental components of the extracted facial features are only significant movements and/or spacing of the speaker's facial features. The processor may quantize the extracted facial features via, for example, wavelet based compression, short-time Fourier transforms, or any other multiresolution analysis method. In this way, any variation of detection angle or insubstantial movement variation will not be considered or will otherwise be given less consideration. Again, in this way, any background data, or “noise,” is not represented in the at least one first data sequence generated based on the authentic audio and/or visual content. The processor may quantize the extracted parameters via 2D versions of the aforementioned methods, as will be appreciated.

The method 30 may then comprise encrypting at 38 with an asymmetric cryptographic function using a private key the at least one first data sequence to generate at least one signal. The asymmetric cryptographic function that is used may be similar to the asymmetric cryptographic function 16 described earlier. The method 30 may also comprise transmitting at 40 the at least one signal such that the signal is recordable and embeddable as a digital signature in a recording of the authentic audio and/or visual content. The embedded digital signature may therefore be generated based on the authentic audio and/or visual content.

In an example, where both audio and visual parameters are extracted and encrypted, two signals may be generated, one for the encrypted audio content and one for the encrypted visual content. The signals for the encrypted visual content may be transmitted as light, or any electromagnetic signal, also referred to herein as light signals. The signals for the encrypted audio content may be transmitted as sound, also referred to herein as sound signals. The sound signals may be, for example, one or more of ultrasound or infrasound. The light signals may be, for example, one or more of ultraviolet light or infrared light. The aforementioned signals may also be in the form of radio signals. Therefore, the light and/or sound signals may be undetectable by the human eye or ear. In an embodiment, however, the light and/or sound signals are at least detectable by a recording device, such that they may be embedded in a resulting recording. The signals may be transmitted so that they may be recorded together with the authentic audio and/or visual content by a recording device. For example, the signals may be transmitted as sound, flashing light, light projected onto the speaker's face or body, an image that is displayed to the audience, (for example, by the display of a speaker's smartphone), such as a machine readable code or a QR code, or any combination thereof. The signals may be transmitted at a predetermined time-delay after encryption by the asymmetric cryptographic function. The signals may therefore be recorded and embedded as a digital signature in the recording of the authentic audio and/or visual content.

With reference to FIG. 3B, the method 30 may further comprise steps for authenticating a recording of allegedly authentic audio and/or visual content embedded with the digital signature generated based on the authentic audio and/or visual content, according to an embodiment. The method 30, therefore, may further comprise extracting at 42 using the predetermined algorithm the at least one predetermined parameter from the recording of the allegedly authentic audio and/or visual content and quantizing at 44 the at least one extracted predetermined parameter into at least one second data sequence associated with the allegedly authentic audio and/or visual content. To authenticate the recording, the method 30 may further comprise verifying at 46, using the asymmetric cryptographic function and the public key, whether the at least one second data sequence could generate the digital signature embedded in the recording of allegedly authentic audio and/or visual content.

Because the digital signature is generated based on the authentic audio and/or visual content, when the at least one second data sequence could generate the digital signature embedded in the recording, the method 30 further comprises determining at 48 that the recording of allegedly authentic audio and/or visual content is of the authentic audio and/or visual content. When, however, the at least one second data sequence could not generate the digital signature embedded in the recording, the method 30 further comprises determining at 50 that the recording of allegedly authentic audio and/or visual content is not of the authentic audio and/or visual content.

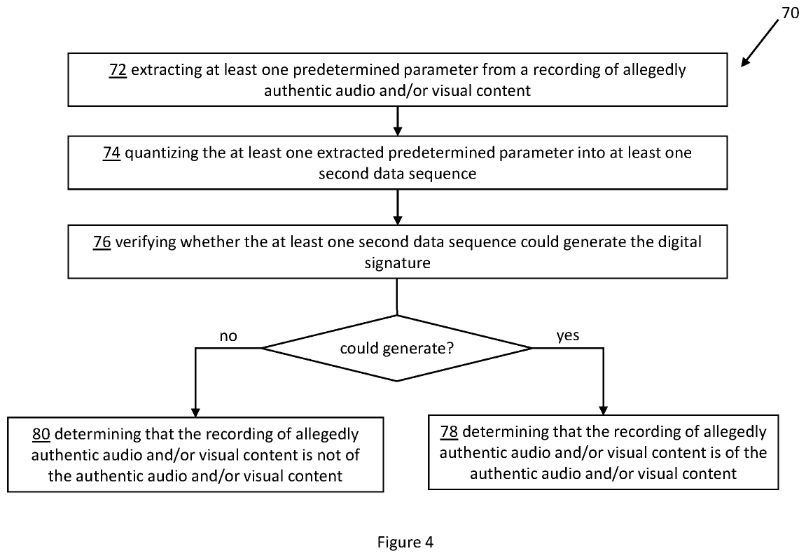

FIG. 4 depicts a method 70 of authenticating a recording of allegedly authentic audio and/or visual content embedded with a digital signature generated based on authentic audio and/or visual content, according to another embodiment. The method 70 comprises extracting at 72 using a predetermined algorithm the at least one predetermined parameter from the allegedly authentic audio and/or visual content and quantizing at 74 the at least one predetermined parameter into at least one second data sequence associated with the allegedly authentic audio and/or visual content. To authenticate the recording, the method 70 may further comprise verifying at 76, using the asymmetric cryptographic function and the public key, whether the at least one second data sequence could generate the digital signature embedded in the recording of allegedly authentic audio and/or visual content.

Because the digital signature is generated based on the authentic audio and/or visual content, when the at least one second data sequence could generate the digital signature embedded in the recording, the method 70 further comprises determining at 78 that the recording of allegedly authentic audio and/or visual content is of the authentic audio and/or visual content. When, however, the at least one second data sequence could not generate the digital signature embedded in the recording, the method 70 further comprises determining at 80 that the recording of allegedly authentic audio and/or visual content is not of the authentic audio and/or visual content.

In an embodiment, a non-transitory computer-readable medium storing program code is provided, which when executed, performs the methods 30 or 70, or any combination thereof.

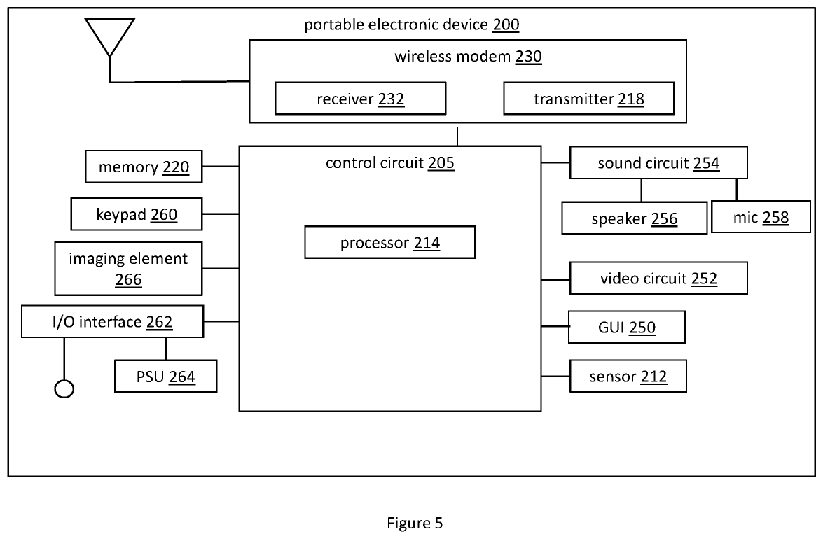

FIG. 5 illustrates a detailed schematic block diagram of an exemplary portable electronic device 200. The previously described first portable electronic device 10 or the second portable electronic device 100 may also comprise the features described herein with respect to the portable electronic device 200, as indicated below. Conversely, the portable electronic device 200 may comprise the features described herein with respect to the first portable electronic device 10 or the second portable electronic device 100. The device 200 may be of any of a variety of devices, such as for example, smartphones, other cellular phones, tablet computers, laptop computers, and other types of computing/communication devices. Smartphone, as the term is used herein, refers to a cellular telephone with an integrated computer that is capable of running software applications. A tablet computer, as the term is used herein, refers to a mobile general-purpose computer with a touchscreen display, circuitry, and battery in a single unit, capable of running software applications. A laptop computer is a mobile general-purpose computer, usually capable of running on battery power.

The device 200 includes a control circuit 205 that is responsible for overall operation of the device 200. For this purpose, the control circuit 205 includes a processor 214 that executes various applications, including applications related to or that form part of the device 200 functioning as described for all embodiments of the present invention. The previously described processors 14 and 114 may also comprise the features described herein with respect to the processor 214. Conversely, the processor 214 may comprise the features described herein with respect to the processors 14 and 114.

In one embodiment, functionality of the device 200, as well as the first and second devices 10 and 100 described above, are embodied in the form of executable logic (e.g., lines of code, software, or a program) that is stored in a memory 220. The previously described memory 20 may also comprise the features described herein with respect to the memory 220. Conversely, the memory 220 may comprise the features described herein with respect to the memory 20. The memory 220 may be a non-transitory computer readable medium of the device 200, and is executed by the processor 214. The described operations may be thought of as a method that is carried out by the device 200. Variations to the illustrated and described techniques are possible and, therefore, the disclosed embodiments should not be considered the only manner of carrying out device 200 functions. The processor 214 and the executable logic may be implemented in the device 200 as hardware, firmware, software, or combinations thereof, and thus, the device 200 and its components provide means for performing functions described herein as performed or executed by the processor 214.

The device 200 may further include a GUI 250, which may be coupled to the processor 214 by a video circuit 252 that converts video data to a video signal used to drive the GUI 250. The video circuit 252 may include any appropriate buffers, decoders, video data processors and so forth.

The device 200 further includes communications circuitry that enables the device 200 to establish communication connections such as a telephone call. In the exemplary embodiment, the communications circuitry includes a radio circuit, such as the wireless modem 230. The wireless modem 230 includes one or more radio frequency transceivers including the receiver 232, the transmitter 218 and an antenna assembly (or assemblies). The previously described transmitter 18 may also comprise the features described herein with respect to the transmitter 218. The device 200 may be capable of communicating using more than one standard or radio access technology (RAT). Thus, the wireless modem 230 including the receiver 232 and the transmitter 218 represents each radio transceiver and antenna needed for the various supported connection types. The wireless modem 230 including the receiver 232 and the transmitter 218 further represents any radio transceivers and antennas used for local wireless communications directly with an electronic device, or over a Bluetooth interface.

As indicated, the device 200 includes the primary control circuit 205 that is configured to carry out overall control of the functions and operations of the device 200. The processor 214 of the control circuit 205 may be a central processing unit (CPU), microcontroller or microprocessor. The processor 214 executes code stored in a memory within the control circuit 205 and/or in a separate memory, such as the memory 220, in order to carry out operation of the device 200. The memory 220 may be, for example, one or more of a buffer, a flash memory, a hard drive, a removable media, a volatile memory, a non-volatile memory, a random-access memory (RAM), or other suitable device. In a typical arrangement, the memory 220 includes a non-volatile memory for long term data storage and a volatile memory that functions as system memory for the control circuit 205. The memory 220 may exchange data with the control circuit 205 over a data bus. Accompanying control lines and an address bus between the memory 220 and the control circuit 205 also may be present. The memory 220 is considered a non-transitory computer readable medium.

The device 200 may further include a sound circuit 254 for processing audio signals. Coupled to the sound circuit 254 are a speaker 256 and a microphone 258 that enable a user to listen and speak via the device 200, and hear sounds generated in connection with other functions of the device 200. The sound circuit 254 may include any appropriate buffers, encoders, decoders, amplifiers and so forth.

The device 200 may further include a keypad 260 that provides for a variety of user input operations. The device 200 may further include one or more input/output (I/O) interface(s) 262. The I/O interface(s) 262 may be in the form of typical electronic device I/O interfaces and may include one or more electrical connectors for operatively connecting the device 200 to another device (e.g., a computer) or an accessory (e.g., a personal handsfree (PHF) device) via a cable. Further, operating power may be received over the I/O interface(s) 262 and power to charge a battery of a power supply unit (PSU) 264 within the device 200 may be received over the I/O interface(s) 262. The PSU 264 may supply power to operate the device 200 in the absence of an external power source.

The device 200 also may include various other components. For instance, the imaging element 266 may be present for taking digital pictures and/or movies. Image and/or video files corresponding to the pictures and/or movies may be stored in the memory 220. As another example, various sensors 212 may be present to sense various sensor data. The previously described sensor 12 may also comprise the same features described herein with respect to the sensors 212. Conversely, the sensors 212 may comprise the features described herein with respect to the sensor 12.

Although the invention has been shown and described with respect to certain preferred embodiments, it is understood that equivalents and modifications will occur to others skilled in the art upon the reading and understanding of the specification. The present invention includes all such equivalents and modifications and is limited only by the scope of the following claims.

1. A first device comprising:
a sensor configured to detect authentic audio and/or visual content,
a processor including an asymmetric cryptographic function using a mathematically paired private key and public key, the processor configured to:
extract using a predetermined algorithm at least one predetermined parameter from the detected authentic audio and/or visual content,
quantize the at least one extracted predetermined parameter into at least one first data sequence associated with the authentic audio and/or visual content, and
encrypt using the asymmetric cryptographic function and the private key the at least one first data sequence to generate at least one signal, and
a transmitter configured to transmit the at least one signal such that the signal is recordable and embeddable as a digital signature in a recording of the authentic audio and/or visual content, the digital signature being generated based on the authentic audio and/or visual content in the recording of the authentic audio and/or visual content.

2. The first device of claim 1 wherein the at least one data sequence represents fundamental components of the at least one extracted predetermined parameter.

3. The first device of claim 1 wherein the at least one predetermined parameter includes at least one of eye movement, lip movement, and sound characteristics.

4. The first device of claim 1 wherein the at least one signal is detectable by a recording device.

5. The first device of claim 1 wherein the at least one signal includes at least one of a sound signal and an electromagnetic signal.

6. The first device of claim 1 wherein the processor is further configured to:
extract using the predetermined algorithm the at least one predetermined parameter from a recording of allegedly authentic audio and/or visual content embedded with the digital signature generated based on the authentic audio and/or visual content,
quantize the at least one extracted predetermined parameter into at least one second data sequence associated with the allegedly authentic audio and/or visual content, and
verify using the asymmetric cryptographic function and the public key whether the at least one second data sequence could generate the digital signature embedded in the recording of allegedly authentic audio and/or visual content.

7. The first device of claim 6 wherein the processor is further configured such that when the processor verifies that the at least one second data sequence could generate the digital signature embedded in the recording of allegedly authentic audio and/or visual content, the digital signature being generated based on the authentic audio and/or visual content, the processor determines that the recording of allegedly authentic audio and/or visual content is of the authentic audio and/or visual content, and when the processor verifies that the at least one second data sequence could not generate the digital signature embedded in the recording of the allegedly authentic audio and/or visual content, the digital signature being generated based on the authentic audio and/or visual content, the processor determines that the recording of allegedly authentic audio and/or visual content is not of the authentic audio and/or visual content.

8. A second device comprising:
a processor including an asymmetric cryptographic function, the processor configured to:
extract using a predetermined algorithm at least one predetermined parameter from a recording of allegedly authentic audio and/or visual content embedded with a digital signature generated based on authentic audio and/or visual content,
quantize the at least one extracted predetermined parameter into at least one second data sequence associated with the allegedly authentic audio and/or visual content, and
verify using the asymmetric cryptographic function and a public key whether the at least one second data sequence could generate the digital signature embedded in the recording of allegedly authentic audio and/or visual content.

9. The second device of claim 8 wherein the processor is further configured such that when the processor verifies that the at least one second data sequence could generate the digital signature embedded in the recording of allegedly authentic audio and/or visual content, the digital signature being generated based on the authentic audio and/or visual content, the processor determines that the recording of allegedly authentic audio and/or visual content is of the authentic audio and/or visual content, and when the processor verifies that they at least one second data sequence could not generate the digital signature embedded in the recording of the allegedly authentic audio and/or visual content, the digital signature being generated based on the authentic audio and/or visual content, the processor determines that the recording of allegedly authentic audio and/or visual content is not of the authentic audio and/or visual content.

10. A method comprising:
detecting authentic audio and/or visual content,
extracting using a predetermined algorithm at least one predetermined parameter from the detected authentic audio and/or visual content,
quantizing the at least one extracted predetermined parameter into at least one first data sequence associated with the authentic audio and/or visual content,
encrypting using an asymmetric cryptographic function and a private key the at least one first data sequence to generate at least one signal, and
transmitting the at least one signal such that the signal is recordable and embeddable as a digital signature in a recording of the authentic audio and/or visual content, the digital signature being generated based on the authentic audio and/or visual content in the recording of authentic audio and/or visual content.

11. The method of claim 10 wherein the at least one data sequence represents fundamental components of the at least one extracted predetermined parameter.

12. The method of claim 10 wherein the at least one predetermined parameter includes at least one of eye movement, lip movement, and sound characteristics.

13. The method of claim 10 wherein the at least one signal is detectable by a recording device.

14. The method of claim 10 wherein the at least one signal includes at least one of a sound signal and an electromagnetic signal.

15. The method of claim 10 further comprising:
extracting using the predetermined algorithm the at least one predetermined parameter from a recording of allegedly authentic audio and/or visual content embedded with the digital signature generated based on the authentic audio and/or visual content,
quantizing the at least one extracted predetermined parameter into at least one second data sequence associated with the allegedly authentic audio and/or visual content, and
verifying using the asymmetric cryptographic function and a public key whether the at least one second data sequence could generate the digital signature embedded in the recording of allegedly authentic audio and/or visual content.

16. The method of claim 15 further comprising:
when the at least one second data sequence could generate the digital signature embedded in the recording of allegedly authentic audio and/or visual content, the digital signature being generated based on the authentic audio and/or visual content, determining that the recording of allegedly authentic audio and/or visual content is of the authentic audio and/or visual content, and
when the at least one second data sequence could not generate the digital signature embedded in the recording of the allegedly authentic audio and/or visual content, the digital signature being generated based on the authentic audio and/or visual content, determining that the recording of allegedly authentic audio and/or visual content is not of the authentic audio and/or visual content.

17. A method comprising:
extracting using a predetermined algorithm at least one predetermined parameter from a recording of allegedly authentic audio and/or visual content embedded with a digital signature generated based on authentic audio and/or visual content,
quantizing the at least one extracted predetermined parameter into at least one second data sequence associated with the allegedly authentic audio and/or visual content, and
verifying using the asymmetric cryptographic function and a public key whether the at least one second data sequence could generate the digital signature embedded in the recording of allegedly authentic audio and/or visual content.

18. The method of claim 17 further comprising:
when the at least one second data sequence could generate the digital signature embedded in the recording of allegedly authentic audio and/or visual content, the digital signature being generated based on the authentic audio and/or visual content, determining that the recording of allegedly authentic audio and/or visual content is of the authentic audio and/or visual content, and
when the at least one second data sequence could not generate the digital signature embedded in the recording of the allegedly authentic audio and/or visual content, the digital signature being generated based on the authentic audio and/or visual content, determining that the recording of allegedly authentic audio and/or visual content is not of the authentic audio and/or visual content.

19. A non-transitory computer-readable medium storing program code which when executed performs the method of claim 10.

20. A non-transitory computer-readable medium storing program code which wen executed performs the method of claim 17.
